(19) United States
(12) Patent Application Publication
(10) Pub. No.: US 2017/0134595 A1
(43) Pub. Date: May 11, 2017

(54) AUTOMATED IMAGE ALBUM

(71) Applicant: Vivint, Inc., Provo, UT (US)

(72) Inventors: Matthew Mahar, Salt Lake City, UT (US); Matthew J. Eyring, Provo, UT (US); Clint H. Gordon-Carroll, Orem, UT (US); Jeremy B. Warren, Draper, UT (US); James E. Nye, Alpine, UT (US); Jefferson H. Lyman, Alpine, UT (US)

(21) Appl. No.: 14/938,480

(22) Filed: Nov. 11, 2015

(51) Int. Cl. H04N 1/00; H04N 5/765; H04N 1/387

(52) U.S. Cl. CPC H04N 1/00196; H04N 1/00161; H04N 1/387; H04N 5/765

(57) ABSTRACT

In some embodiments, security and/or automation systems may offer users automated generation of shared albums among individuals relating to one or more events. The individuals may be known individuals or unknown individuals. For example, the albums may be of intimate settings such as holiday meals or birthdays, or may be from larger gatherings such as concerts, fairs, and the like. The user may have the ability to generate hard copy and/or electronic albums that can then be shared. The users may have the option to customize the album and review the images for printing of only select images.

### BACKGROUND

The present disclosure, for example, relates to security and/or automation systems, and more particularly to generating group photo albums and/or image and media collections.

Security and automation systems are widely deployed to provide various types of communication and functional features such as monitoring, communication, notification, and/or others. These systems may be capable of supporting communication with a user through a communication connection or a system management action.

People often have gatherings and get-togethers but don't often share images, whether picture or movie, to develop an album to commemorate the event and capture the memories. Often times, images are left on mobile devices and/or cameras and are not downloaded or shared, even if users intend to later send images. Conversely, some images may be selectively posted to social media or shared, but the images may be altered or difficult to download. Thus, there exists a need in the art for improved collecting and generating of picture and movie media.

### SUMMARY

In some embodiments, security and/or automation systems, collectively referred to as automation systems, may offer users automated generation of shared albums among individuals. The individuals may be known or unknown individuals. For example, the albums may be of intimate settings such as holiday meals, birthdays, and/or anniversaries, or may be from larger gatherings such as concerts, fairs, and the like. The user may have the ability to generate electronic and/or hard copy albums that can then be shared and/or delivered electronically or manually. The users may have the option to customize the album and review the images for printing of only select images, among other things.

In some embodiments, a method for security and/or automation systems is described. In some embodiments, the method may include establishing a connection with a camera device and setting connection parameters based at least in part on the establishing. In some embodiments, the method may include dynamically receiving images captured by the camera device based at least in part on the connection parameters and generating an album of images based at least in part on the receiving and the connection parameters.

In some embodiments, the method may include predicting generation of a special album request based at least in part on a calendar notification. In some embodiments, the method may include enabling image sharing by a group of people and enabling selective image downloading from the image sharing. In some embodiments, the group of people may be established at least in part by generating a geographical boundary around a location associated with a public event. In some embodiments, the method may include requesting permission to access or receive images relating to the public event.

In some embodiments, the connection parameters may include setting a start time for dynamically receiving images and setting an end time for dynamically receiving images. In some embodiments, the start time and the end time may coordinate with a calendar event on a user's calendar. In another instance, the start time and the end time may coordinate with a holiday. In some embodiments, establishing the connection with the camera device may include establishing a connection with camera devices proximate multiple mobile devices.

In another instance, a user of an automation system may determine the mobile devices selected for establishing the connection. In some embodiments, the method may include automatically requesting a physical album to be generated. In some embodiments, generating the album of images may be based at least in part a previously generated album. In some embodiments, generating the album of images may be based at least in part a previous public event. In some embodiments, the connection parameters may define the album.

In another embodiment, an apparatus for security and/or automation systems is described. In some embodiments, the apparatus may include a processor, memory in electronic communication with the processor, and instructions stored in the memory. In some embodiments, the instructions may be executable by the processor to establish a connection with a camera device and set connection parameters based at least in part on the establishing. In some embodiments, the instructions may dynamically receive images captured by the camera device to a server based at least in part on the connection parameters and generate an album of images based at least in part on the receiving and the connection parameters.

In another embodiment, a non-transitory computer-readable medium storing computer-executable code is described. In some embodiments, the code may be executable by a processor to establish a connection with a camera device and set connection parameters based at least in part on the establishing. In some embodiments, the code may be executable by a process to dynamically receive images captured by the camera device to a server based at least in part on the connection parameters and generate an album of images based at least in part on the receiving and the connection parameters.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein—including their organization and method of operation—together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components—including those having a dash and a second reference label—apply to other similar components. If only the first reference label is used in the specification, the description is applicable to any one of the similar components having the same first reference label irrespective of the second reference label.

FIG. 1 is a block diagram of an example of a security and/or automation system, in accordance with various aspects of this disclosure;

FIG. 2 shows a block diagram of a device relating to a security and/or an automation system, in accordance with various aspects of this disclosure;

FIG. 3 shows a block diagram of a device relating to a security and/or an automation system, in accordance with various aspects of this disclosure;

FIG. 4 shows a block diagram relating to a security and/or an automation system, in accordance with various aspects of this disclosure;

FIG. 5 shows a swim diagram of a process relating to a security and/or an automation system, in accordance with various aspects of this disclosure;

FIG. 6 is a flow chart illustrating an example of a method relating to a security and/or an automation system, in accordance with various aspects of this disclosure; and

FIG. 7 is a flow chart illustrating an example of a method relating to a security and/or an automation system, in accordance with various aspects of this disclosure.

### DETAILED DESCRIPTION

In some embodiments, security and/or automation systems, collectively referred to as automation systems, may offer users automated generation of shared albums from gatherings and/or event involving individuals. Often, at events, different people take pictures with various devices but the pictures are either unshared, or posted to social media sites that may make gathering all of the collective images difficult. People want to easily view photographs from an event and either generate albums or print individual photographs from the event for their own use or for gifting and/or other purposes.

The individuals sharing images may be known individuals or unknown individuals. For example, the albums may be of intimate settings such as holiday meals, birthdays, and/or anniversaries gatherings or may be from larger gatherings such as concerts, fairs, school functions, and the like. The images may be still images and/or may be video images. The images may be accessible to a person through multiple mediums such as a web-site, a program on a computer, a control panel associated with an automation system, a mobile device, some combination, and/or the like.

The following description provides examples and is not limiting of the scope, applicability, and/or examples set forth in the claims. Changes may be made in the function and/or arrangement of elements discussed without departing from the scope of the disclosure. Various examples may omit, substitute, and/or add various procedures and/or components as appropriate. For instance, the methods described may be performed in an order different from that described, and/or various steps may be added, omitted, and/or combined. Also, features described with respect to some examples may be combined in other examples.

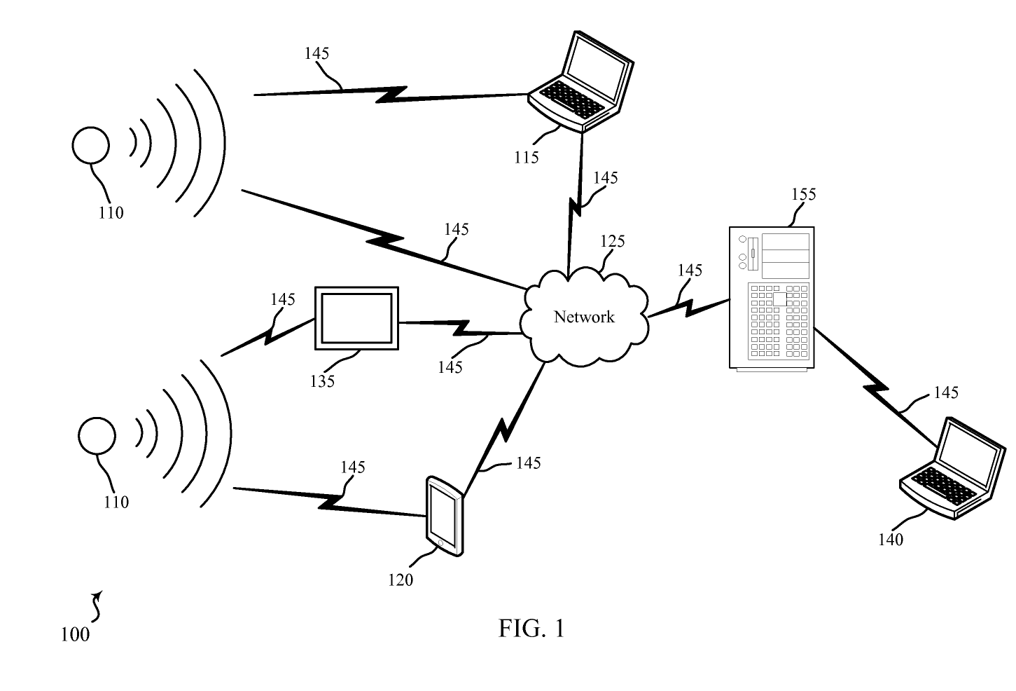

FIG. 1 is an example of a communications system 100 in accordance with various aspects of the disclosure. In some embodiments, the communications system 100 may include one or more sensor units 110, local computing devices 115, 120, network 125, server 155, control panel 135, and/or remote computing device 140. One or more sensor units 110 may communicate via wired or wireless communication links 145 with one or more of the local computing device 115, 120 or network 125. The network 125 may communicate via wired or wireless communication links 145 with the control panel 135 and the remote computing device 140 via server 155. In alternate embodiments, the network 125 may be integrated with any one of the local computing device 115, 120, server 155, or remote computing device 140, such that separate components are not required.

Local computing devices 115, 120 and remote computing device 140 may be custom computing entities configured to interact with sensor units 110 via network 125, and in some embodiments, via server 155. In other embodiments, local computing devices 115, 120 and/or remote computing device 140 may be general purpose computing entities such as a personal computing device, for example, a desktop computer, a laptop computer, a netbook, a tablet personal computer (PC), a control panel, an indicator panel, a multi-site dashboard, an iPod®, an iPad®, a smart phone, a smart camera for indoor and/or outdoor use, a mobile phone, a mobile device including a camera device a personal digital assistant (PDA), and/or any other suitable device operable to send and receive signals, store and retrieve data, and/or execute modules.

The control panel 135 may be a smart home system panel, for example, an interactive panel mounted on a wall in a user's home. Control panel 135 may be in direct communication via wired or wireless communication links 145 with the one or more sensor units 110, or may receive sensor data from the one or more sensor units 110 via local computing devices 115, 120 and network 125, or may receive data via remote computing device 140, server 155, and network 125.

The local computing devices 115, 120 may include memory, a processor, an output, a data input and a communication module. The processor may be a general purpose processor, a Field Programmable Gate Array (FPGA), an Application Specific Integrated Circuit (ASIC), a Digital Signal Processor (DSP), and/or the like. The processor may be configured to retrieve data from and/or write data to the memory. The memory may be, for example, a random access memory (RAM), a memory buffer, a hard drive, a database, an erasable programmable read only memory (EPROM), an electrically erasable programmable read only memory (EEPROM), a read only memory (ROM), a flash memory, a hard disk, a floppy disk, cloud storage, and/or so forth. In some embodiments, the local computing devices 115, 120 may include one or more hardware-based modules (e.g., DSP, FPGA, ASIC) and/or software-based modules (e.g., a module of computer code stored at the memory and executed at the processor, a set of processor-readable instructions that may be stored at the memory and executed at the processor) associated with executing an application, such as, for example, receiving and displaying data from sensor units 110.

The processor of the local computing devices 115, 120 may be operable to control operation of the output of the local computing devices 115, 120. The output may be a television, a liquid crystal display (LCD) monitor, a cathode ray tube (CRT) monitor, speaker, tactile output device, and/or the like. In some embodiments, the output may be an integral component of the local computing devices 115, 120. Similarly stated, the output may be directly coupled to the processor. For example, the output may be the integral display of a tablet and/or smart phone. In some embodiments, an output module may include, for example, a High Definition Multimedia Interface™ (HDMI) connector, a Video Graphics Array (VGA) connector, a Universal Serial Bus™ (USB) connector, a tip, ring, sleeve (TRS) connector, and/or any other suitable connector operable to couple the local computing devices 115, 120 to the output.

The remote computing device 140 may be a computing entity operable to enable a remote user to monitor the output of the sensor units 110. The remote computing device 140 may be functionally and/or structurally similar to the local computing devices 115, 120 and may be operable to receive data streams from and/or send signals to at least one of the sensor units 110 via the network 125. The network 125 may be the Internet, an intranet, a personal area network, a local area network (LAN), a wide area network (WAN), a virtual network, a telecommunications network implemented as a wired network and/or wireless network, etc. The remote computing device 140 may receive and/or send signals over the network 125 via wireless communication links 145 and server 155.

In some embodiments, the one or more local computing devices 120 may be linked to and/or include a camera device, or may be a camera device. For example, the local computing device 120 itself may be a camera device with Wi-Fi connectivity or other connectivity capabilities. The camera device may be within a select proximity of a mobile device to establish a connection. The camera device may connect to a mobile device within a predetermined distance such as 10 feet, 100 feet, 100 yards, etc. The camera device may, in some embodiments, be integrated into a mobile device such as a smart phone or other camera-capable mobile phone and/or device. In some embodiments, the camera device may additionally be integrated into a personal computer, a tablet, a watch, eyewear, and/or other personal technological devices. In some embodiments, the camera device may be and/or include a sensor unit 110 and/or other feature or component associated with the automation system. For example, the camera device may be a security device capable of capturing high-quality images.

In some embodiments, the camera device may be capable of taking still and/or video images. The local computing devices 120 may connect to the server 155 and/or control panel 135 via the network 125. The local computing devices 120 may collect images via the camera device and/or from other sources, and transmit the images to the server 155 and/or control panel 135 via the network 125. In some embodiments, the control panel 135 and/or the server 155 may additionally pull the images from the local computing devices 120. The images may be linked to specific events and the server 155 and/or control panel 135 may require special permissions to access the images. In other embodiments, the server 155 and/or control panel 135 may have an established connection with predetermined permissions to access, upload, and/or receive images from the local computing device 120. For example, a user may enter access data into a dedicated application on his smart phone indicating permissions to access images on and/or from the local computing device 120.

In some embodiments, images gathered by the one or more local computing devices 120 may also be communicated to local computing device 115, 120, which may be, in some embodiments, a wall-mounted input/output smart home display. In alternate embodiments, remote computing device 140 may process the images received from the one or more local computing devices 120, via network 125 and server 155, to generate image albums. Data transmission may occur via, for example, frequencies appropriate for a personal area network (such as BLUETOOTH® or IR communications) or local or wide area network frequencies such as radio frequencies specified by the IEEE 802.15.4 standard.

In some embodiments, local computing device 115, 120 may communicate with remote computing device 140 or control panel 135 via network 125 and server 155. Examples of networks 125 include cloud networks, local area networks (LAN), wide area networks (WAN), virtual private networks (VPN), wireless networks (using 802.11, for example), and/or cellular networks (using 3G and/or LTE, for example), etc. In some configurations, the network 125 may include the Internet. In some embodiments, a user may access the functions of local computing device 115, 120 from remote computing device 140. For example, in some embodiments, remote computing device 140 may include a mobile application that interfaces with one or more functions of local computing device 115, 120.

The server 155 may be configured to communicate with the sensor units 110, the local computing devices 115, 120, the remote computing device 140 and control panel 135. The server 155 may perform additional processing on signals received from the sensor units 110 or local computing devices 115, 120, or may simply forward the received information to the remote computing device 140 and control panel 135.

Server 155 may be a computing device operable to receive data streams (e.g., from sensor units 110 and/or local computing device 115, 120 or remote computing device 140), store and/or process data, and/or transmit data and/or data summaries (e.g., to remote computing device 140). For example, server 155 may receive a stream of image data from a local computing device 120, a stream of image data from the same or a different local computing device 120, and a stream of image data from either the same or yet another local computing device 120. In some embodiments, server 155 may “pull” the data streams (e.g., by querying the local computing devices 120, the local computing devices 115, and/or the control panel 135). In some embodiments, the data streams may be “pushed” from the local computing devices 120 and/or the local computing devices 115 to the server 155. For example, the local computing devices 120 and/or the local computing devices 115 may be configured to transmit data as it is generated by or entered into that device. In some instances, local computing devices 120 and/or the local computing devices 115 may periodically transmit data (e.g., as a block of data or as one or more data points).

The server 155 may include a database (e.g., in memory, remotely located) containing image data received from the local computing devices 120 and/or the local computing devices 115. Additionally, as described in further detail herein, software (e.g., stored in memory) may be executed on a processor of the server 155. Such software (executed on the processor) may be operable to cause the server 155 to monitor, process, summarize, present, and/or send a signal associated with resource usage data.

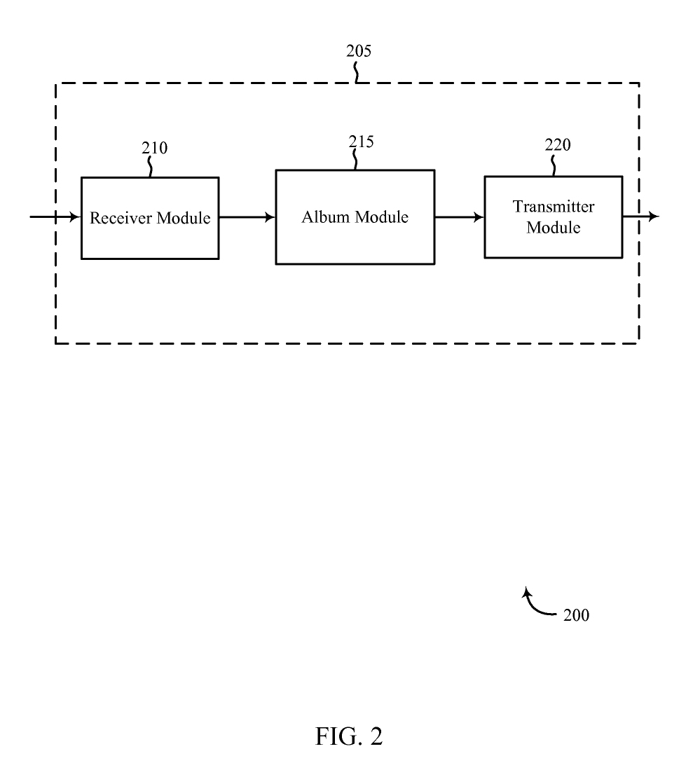

FIG. 2 shows a block diagram 200 of a device 205 for use in electronic communication, in accordance with various aspects of this disclosure. The device 205 may be an example of one or more aspects of a control panel 135 and/or server 155 described with reference to FIG. 1. The device 205 may include a receiver module 210, an album module 215, and/or a transmitter module 220. The device 205 may also be or include a processor. Each of these modules may be in communication with each other—directly and/or indirectly.

The components of the device 205 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

The receiver module 210 may receive information such as packets, user data, and/or control information associated with various information channels (e.g., control channels, data channels, etc.). The receiver module 210 may be configured to receive images from one or more devices such as mobile devices. The receiver module 210 may additionally receive permission to access the images on a device. The receiver module 210 may additionally receive information pertaining to access parameters and/or connection parameters, and/or album generation information. Information may be passed on to the album module 215, and to other components of the device 205.

The album module 215 may generate image albums for events. The events may be pre-generated and/or pre-selected by a user or may be automatically detected by the album module 215 from one or more data sources. For example, the album module 215 may link to a user's calendar and/or social media to determine an upcoming event. The event may be a specific event such as a birthday, holiday, celebration or the like. The event may also be a generic event such as gathering, barbeque, or the like. The event may include and/or list a location and may be at the location of an automation system or may be remote such as at a park or other venue. In another embodiment, the event and at least some related characteristics may be programmed by the individual (e.g., manually, in response to a query by one or more devices, etc.).

In further embodiments, the album module 215 may receive input from one or more sensors which may detect the projected and/or potential occurrence of future events. For example, the automation system may detect people, such as parents, discussing event details such as a party, decorations, candles, presents, invitees, invitations, and the like. The album module 215 may prompt the individuals to generate an image album in conjunction with the upcoming event. In other embodiments, the album module 215 may receive information such as visual input and/or movement of people preparing for an event to trigger album generation. In still further embodiments, the album module 215 may receive input of a large number of guests arriving to the home. For example, a smart doorbell camera may detect the arrival of multiple guests which may trigger an event, whether impromptu or planned and may ping a user on album generation.

In some embodiments, the album module 215 may detect attendees of the event and/or the user may preload attendees (e.g., based on detected characteristics such as through facial recognition and/or other identifying information, by having an identifying device, etc.). Attendees may be requested to download an application to their mobile device, tablet, and/or computer to share images from the event. Once the application is installed, it may request permission to access the images for a select date and/or time range. This will enable attendees to become image contributors to the event album, while still maintaining privacy for other non-selected dates and/or time ranges. The date and time range may be associated with the specific event and the application may label the event in the permissions request.

In some embodiments, once an image contributor grants permissions, images may automatically be uploaded to a server (e.g. server 155) through the use of the application and/or in other ways. The images may be uploaded to a shared album available to all attendees of the event, some subset of the attendees, and/or only to selected individuals. In some embodiments, one need not be a contributor to have access to the event. For example, not everyone may have a smart phone or may take photographs but may wish to have access to the albums, such as a grandmother who does not have a device or could not attend but who still wants to view the images. The images may additionally be pulled by the server.

In some embodiments, the album module 215 may initiate generating a tactile album. The album may automatically be generated and mailed to a user of the application and/or automation system, automatically and/or based on one or more instructions. A third party may also have access to the album. For example, a tactile album may be useful in the instance of non-technical person such as a grandmother or grandfather. The album may enable the family to have access to the images without the need to access a computer or click through images, allowing people to re-live the experience through a tactile album.

In other embodiments, the album may comprise images from a larger group of people. For example, the album module 215 may generate an album for a large event such as a concert, a school event, etc. The album module 215 may request permissions to upload photos for every person with the application within a predetermined physical area for a predetermined event associated with a time period. Each user may opt into uploading their photos to the shared group album. The user may then be able to download specific photos from the event to a personal album.

The transmitter module 220 may transmit the one or more signals received from other components of the device 205. The transmitter module 220 may transmit one or more photos and/or videos, and/or links to a photo album to a user. The transmitter module 220 may additionally transmit an album to a third party to initiate generation of a tactile album. In some embodiments, the transmitter module 220 may transmit requests to camera devices to receive and/or download/upload images from the camera device. In some examples, the transmitter module 220 may be collocated with the receiver module 210 in a transceiver module.

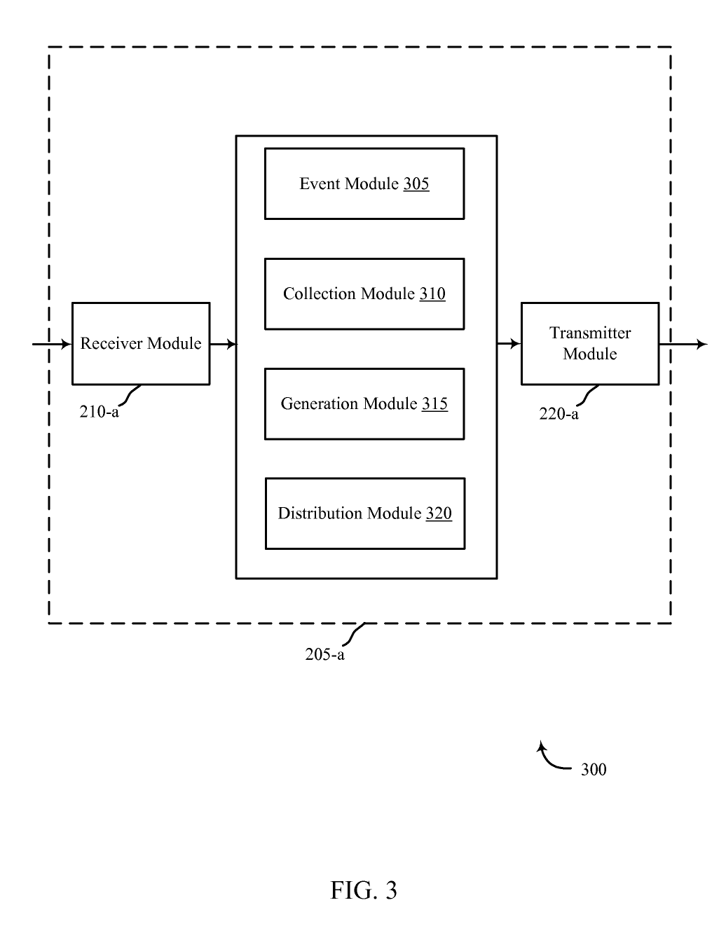

FIG. 3 shows a block diagram 300 of a device 205-a for use in wireless communication, in accordance with various examples. The device 205-a may be an example of one or more aspects of a control panel 105 and/or server 155 described with reference to FIG. 1. It may also be an example of a device 205 described with reference to FIG. 2. The device 205-a may include a receiver module 210-a, an album module 215-a, and/or a transmitter module 220-a, which may be examples of the corresponding modules of device 205. The device 205-a may also include a processor. Each of these components may be in communication with each other. The album module 215-a may include event module 305, collection module 310, generation module 315, and/or distribution module 320, among others. The receiver module 210-a and the transmitter module 220-a may perform the functions of the receiver module 210 and the transmitter module 220, of FIG. 2, respectively.

The components of the device 205-a may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

The event module 305 may generate an album request based on an event. The event may be a calendar event, a holiday, a user-requested event, a social media event, a public event, and/or the like. After the event module 305 detects the event or receives a request for the vent, the event module 305 may determine one or more parameters of the event. The parameters may include the event location, the event start and end time, image contributors, attendees, an importance identifier, a categorization, and/or the like.

The event location may be a labeled location such as “home” or “grandma's” or “the park,” etc. Alternatively, the event location may be based at least in part on a predetermined geo-fence surrounding a predefined location. The location may have similar names such as “home,” “grandma's” or “the park” but may have an established geo-fence boundary and/or may be derived. In some embodiments, this boundary may derived from past events, property lines, locations of one or more people and/or devices, noise-based determinations, some combination, and/or other things. In some embodiments, the location may be specific to an event and/or location, such as Candlestick Park in San Francisco for a football game or a concert. The location may be specific to a room in a residence or building or may be based on defining a region on a map. The location may be based on density of the devices and/or other analytics, geographically based (e.g., around a football field), based on identified areas using social media, and the like.

The start and end times may be established by event information or may be learned information. For example, if the event is generated based on a calendar event, the calendar event may establish a start time and an end time. If the event is based on a public event, such as a concert, the event module 305 may use the start time and end times of the concert to set time parameters around the event. The event module 305, in some instances, may add a predetermined amount of time prior to the beginning and after the ending of the calendar or public event to ensure all images of the event are captured. For example, the event module 305 may set the parameters of the event to start two hours, one hour, or thirty minutes before its actual time and end two hours, one hour, or thirty minutes after the actual end time. In some embodiments, this start and end time may be based at least in part on the type of event and/or some classification of an event. For example, if the event relates to a performance where the performers are available after the event, then the parameters may include only capturing information thirty minutes before the start of the event but may include capturing information for an hour after the event to capture the most relevant information.

In other instances, the event module 305 may predict a start and an end time. For example, a user may have a recurring event each week, month and/or year that starts and ends at similar times each period. In another embodiment, the event may be linked to a holiday such as Thanksgiving and the time event parameters may encompass the entirety of the day to ensure pictures of cooking and preparation etc. are captured. In some embodiments, an indoor device 115 (e.g., a stand-alone indoor camera) may be activated to record video, still images, and/or audio for the entire duration of the event. In some embodiments, an indoor device 115 (e.g., a stand-alone indoor camera) may be activated to record video, still images, and/or audio for some portion of the duration of the event. In some embodiments, if the event is a user-requested event, the user may be prompted to enter in start and end times of the event. If the event module 305 assumes the start and end times of the event, the event module 305 may prompt the user to confirm, alter, and/or otherwise edit the time settings. In some embodiments, a user may additionally have the option to delete the event entirely. The start and end time of the event may establish the range of which images with a select time stamp may be received and shared.

In some embodiments, one or more devices may begin recording based on recognized data and/or inputs in conjunction with event module 305. For example, an indoor camera device may begin recording based on input to one or more sensor units 150 and/or other devices 115, 120 within and/or relating to a home. One example may include recognizing key words stored in database (based on defaults and/or learned key words from past events) that may be spoken when one or more people are present at the home. When a person yells “Happy Birthday!” or “Merry Christmas!” the device may identify these words as a potential event and may take certain action based on this identification. Another example may include identifying one or more devices that are capturing image data (e.g., pictures, videos), and taking certain action based on the action of the other devices. So an indoor camera device, for example, may determine that a mobile device is capturing image data at a first location (e.g., in a backyard), and then the indoor camera device may automatically take a certain action (e.g., capturing a image data) at a second location (e.g., in a family room) based on the action of the mobile device. Other variations of this method, determinations, and such action are contemplated. This action may include, among other things, capturing additional information to predict whether this is an actual event and/or automatically recording audio, still image, and/or video image data based on the recognized key words, the action of one or more other devices, some combination, and/or other things.

The event module 305 may additionally establish a connection with various image contributors. The image contributors may be guests or attendees of the event with a camera device. The event module 305 may receive information from a user which may enable the album module 215-a to connect to a device (e.g. a camera device) associated with the image contributor. In some embodiments, the image contributors may be users of the automation system. In other embodiments, the image contributors may be guests of a person having the automation system but, as discussed further below, may be requested to link to the automation system and/or other device.

In some embodiments, the event module 305 may predict the image contributors based on multiple factors. For example, the event module 305 may access a calendar event and may predict the calendar invitees to be image contributors. The event module 305 may use the location of the event to determine image contributors. For example, if the event is a public event and the event generation is a public album sharing, the event module 305 may, as discussed later, request that users within a geo-fence surrounding the location of the public event become image contributors.

The event module 305 may generate a public event which may be shared, as discussed further below. The event module 305 may receive a notification of a public event such as a concert, block party, carnival, school function, parade, air show, car show, athletic event such as a half-marathon, sporting event, movie event, and the like. The event module 305 may identify a location associated with the event and determine an established geo-fence surrounding the location. The event module 305 may independently generate event parameters since the event is not linked only to a user but to a public event. For example, the event module 305 may determine image contributors, time start and end dates, and sharing features. To determining the image contributors, the event module 305 may then ping all users of the automation system within the geo-fence a predetermined time before the event. The ping may include information regarding the public event and the information that may be shared which the event module determined 305. This may be performed, as discussed further below, by the collection module 310.

The collection module 310 may collect all of the images from the image contributors. The collection module 310 may establish a connection with different image contributors and set the connection parameters for each image contributor. The connection may be established with a camera device associated with each of the image contributors. The connection parameters may be established by the event module 305 and may be presented to the image contributor via the camera device to establish the connection. For example, the event module 305 may have a start and end time and sharing parameters of images. The image contributor may have the option to accept, alter, and/or reject select parameters.

For example, for a public event, the image contributor may have the option to share select images and may alter the start and end time in which images taken may be shared. The image contributor may not wish for images prior to the event to be shared, such as images taken during tailgating, but may be okay with images taken during the event to be shared. In another embodiment, the image contributor may not wish for any photos of themselves to be shared. The collection module 310 may recognize images which contain the image contributor, based on facial recognition, a designated profile, and/or other characteristics, and not share them in a public event album.

For a private event, the collection module 310 may request permission to connect to a camera device to which the image contributor may respond. The image contributor may again accept, alter, and/or reject the connection parameters. The connection parameters may include start time, end time, image sharing options, and the like. In some instances, the image contributor may wish to only share images with other select event attendees and may set privacy settings as such. For example, at a wedding, an image contributor may wish to only share images with other college friends there if the wedding is not a family wedding for the image contributor.

The collection module 310 may receive images captured by the camera device and/or camera devices based at least in part on connection parameters. The images may be saved to a server (e.g. remote server 155). In some embodiments, the server may be associated with a residential automation system. The images may alternatively be saved at a remote server associated with an automation system provider. The camera device may upload the images onto the server or the server may pull and download the images from the camera device. In some embodiments, the images may be sideloaded from a mobile device to a local computer (e.g., local computer device 115, control panel 135). The images may then be transferred from the local computer to a server or another location to generate the album.

The generation module 315 may receive the images from the collection module 310 and organize and generate the image album. Generating the album may include arrange the images in a cohesive manner. For example, the collection module 310 may collect a few dozen images or may collect thousands of images. The generation module 315 may not use all of the images in an album. Some of the images may be blurry, may be repetitive, or may have a lack of interesting subject matter. The generation module 315 may also cohesively organize the images along the time stamp associated with the image to provide a steady story line to an event. For example, the generation module 315 may disregard certain images based on analysis and/or preferences by one or more contributors. The generation module 315 may analyze each image for clarity, edge detection, facial recognition, lighting conditions, some combination, and/or other things to determine whether to include an image as part of the collection or album. If the generation module 315 has a list of attendees to an event and image of the attendees, the generation module 315 may additionally use recognition techniques to ensure all attendees are adequately represented in the album, which may be based on the number of times each attendee is shown in the collection, the number of images included from each attendee's device, some combination, and/or other information. Alternatively, the generation module 315 may use recognition techniques to analyze the images for all attendees and may distribute attendees images and likeness through the album.

In some instances, the generation module 315 may generate multiple albums for a single event. For example, the generation module 315 may generate a “soft” version of the album for electronic distribution and may additionally generate a “hard” version for tactile distribution of the album. The generation module 315 may additionally and/or alternatively create different albums for different image contributors. One image contributor may wish for a select type of album arrangement and photograph focus (e.g., photos of people) while another image contributor may desire another (e.g., photos of the venue, landscape, etc.). The generation module 315 may have a profile for repeat image contributors which it may use to generate the album. In another embodiment, the generation module 315 may receive album preferences directly from the image contributor. The generation module 315 may additionally generate the albums based on a previously generated album by identifying characteristics and/or contributor choices relating to album generation and then including the same and/or different characteristics for the later album. The album may additionally be generated based on a previous public event. In some embodiments, the connection parameters may define the album.

The distribution module 320 may distribute the album and/or albums to different image contributors. In some embodiments, the albums may additionally be distributed to other select people. For example, the distribution module 320 may generate a hyperlink to send to select recipients of the album. The distribution module 320 may additionally and/or alternatively send a file to recipients. The file and/or its sub-elements may be editable. In another embodiment, the album may be a link to a pre-generated product such as a pre-generated image album with a vendor that the recipient may edit prior to purchasing. The image album may additionally contain images not included in the album to allow the recipient to customize the album. In still further embodiments, the distribution module 320 may distribute a tactile album. For example, a recipient may not be technically savvy and may require assistance. Therefore, the distribution module 320 may purchase and distribute a physical album to select recipients based on predetermined selections of photos and/or contributions. For example, in some embodiments, the predetermined selections may include audio clips and/or video clips of the actual concert (or other event detected), such that when a person receives the album the person can observe the audio and/or video clips. In some instances, the physical album may include a screen and/or a speaker, that may include a power source and memory storing at least one video and/or audio clip of at least part of the event. In further embodiments, even technically savvy recipients may wish for a physical album to be distributed.

The distribution module 320 may additional allow image sharing by a group of people. For example, even though the album is distributed, individuals may have the option to download, edit, or otherwise utilize select images from the album. This may include enabling selective image downloading from the image sharing. In still further embodiments, the distribution module 320 may distribute the album with various social media. The social media may enable recipients to share select images and/or distribute the album to their social network.

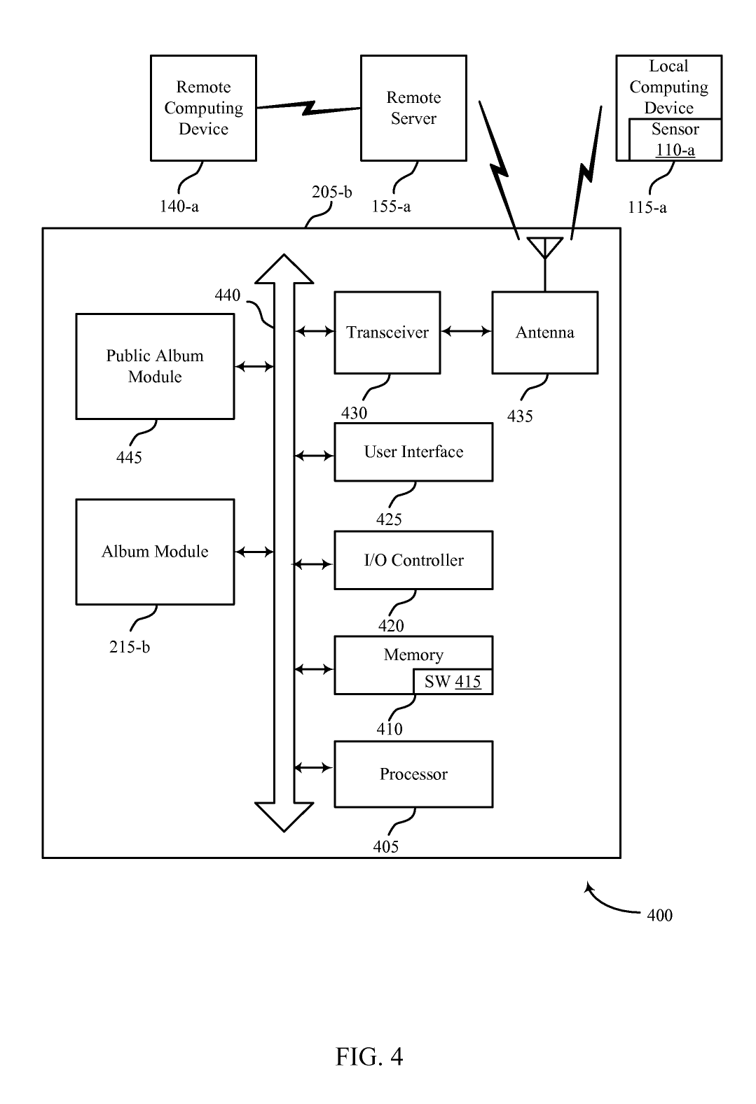

FIG. 4 shows a system 400 for use in image album generation systems, in accordance with various examples. The system 400 may include a device 205-b, which may be an example of the control panels 105 and/or server 155 of FIG. 1, among others. The device 205-b may also be an example of one or more aspects of the device 205 and/or 205-a of FIGS. 2 and 3.

The device 205-b may include a public album module 445, which may be an example of a portion of the album module 215 described with reference to FIGS. 2 and/or 3. The public album module 445 may reside on a server 155-a and may have the features described previously to generate public albums for public events.

The device 205-b may also include components for bi-directional voice and data communications including components for transmitting communications and components for receiving communications. For example, the device 205-b may communicate bi-directionally with one or more of a local computing device 115-a, one or more sensor units 110-a, remote computing device 140, and/or remote server 155-a, which may be an example of the remote server of FIG. 1. This bi-directional communication may be direct (e.g., device 205-b communicating directly with remote computing device 140) or indirect (e.g., device 205-b communicating indirectly with remote server 155-a through remote computing device 140).

The device 205-b may also include a processor module 405, and memory 410 (including software/firmware code (SW) 415), an input/output controller module 420, a user interface module 425, a transceiver module 430, and one or more antennas 435 each of which may communicate—directly or indirectly—with one another (e.g., via one or more buses 440). The transceiver module 430 may communicate bi-directionally—via the one or more antennas 435, wired links, and/or wireless links—with one or more networks or remote devices as described above. For example, the transceiver module 430 may communicate bi-directionally with one or more of local computing device 115-a, remote computing device 140, and/or remote server 155-a. The transceiver module 430 may include a modem to modulate the packets and provide the modulated packets to the one or more antennas 435 for transmission, and to demodulate packets received from the one or more antenna 435. While a device (e.g., 205-b) may include a single antenna 435, the device may also have multiple antennas 435 capable of concurrently transmitting or receiving multiple wired and/or wireless transmissions. In some embodiments, one element of device 205-b (e.g., one or more antennas 435, transceiver module 430, etc.) may provide a direct connection to a remote server 155-a via a direct network link to the Internet via a POP (point of presence). In some embodiments, one element of device 205-b (e.g., one or more antennas 435, transceiver module 430, etc.) may provide a connection using wireless techniques, including digital cellular telephone connection, Cellular Digital Packet Data (CDPD) connection, digital satellite data connection, and/or another connection.

The signals associated with system 400 may include wireless communication signals such as radio frequency, electromagnetics, local area network (LAN), wide area network (WAN), virtual private network (VPN), wireless network (using 802.11, for example), 345 MHz, Z-WAVE®, cellular network (using 3G and/or LTE, for example), and/or other signals. The one or more antennas 435 and/or transceiver module 430 may include or be related to, but are not limited to, WWAN (GSM, CDMA, and WCDMA), WLAN (including BLUETOOTH® and Wi-Fi), WMAN (WiMAX), antennas for mobile communications, antennas for Wireless Personal Area Network (WPAN) applications (including RFID and UWB). In some embodiments, each antenna 435 may receive signals or information specific and/or exclusive to itself. In other embodiments, each antenna 435 may receive signals or information not specific or exclusive to itself.

In some embodiments, one or more sensor units 110-a (e.g., motion, proximity, smoke, light, glass break, door, window, carbon monoxide, and/or another sensor) may connect to some element of system 400 via a network using one or more wired and/or wireless connections.

In some embodiments, the user interface module 425 may include an audio device, such as an external speaker system, an external display device such as a display screen, and/or an input device (e.g., remote control device interfaced with the user interface module 425 directly and/or through input/output controller module 420).

One or more buses 440 may allow data communication between one or more elements of device 205-b (e.g., processor module 405, memory 410, input/output controller module 420, user interface module 425, etc.).

The memory 410 may include random access memory (RAM), read only memory (ROM), flash RAM, and/or other types. The memory 410 may store computer-readable, computer-executable software/firmware code 415 including instructions that, when executed, cause the processor module 405 to perform various functions described in this disclosure (e.g., establish connection parameters with a camera device, receive images from a camera device, generate an image album, etc.). Alternatively, the computer-executable software/firmware code 415 may not be directly executable by the processor module 405 but may cause a computer (e.g., when compiled and executed) to perform functions described herein. Alternatively, the computer-readable, computer-executable software/firmware code 415 may not be directly executable by the processor module 405 but may be configured to cause a computer (e.g., when compiled and executed) to perform functions described herein. The processor module 405 may include an intelligent hardware device, e.g., a central processing unit (CPU), a microcontroller, an application-specific integrated circuit (ASIC), etc.

In some embodiments, the memory 410 can contain, among other things, the Basic Input-Output system (BIOS) which may control basic hardware and/or software operation such as the interaction with peripheral components or devices. For example, the public album module 445 to implement the present systems and methods may be stored within the memory 410. Applications resident with system 400 are generally stored on and accessed via a non-transitory computer readable medium, such as a hard disk drive or other storage medium. Additionally, applications can be in the form of electronic signals modulated in accordance with the application and data communication technology when accessed via a network interface (e.g., transceiver module 430, one or more antennas 435, etc.).

Many other devices and/or subsystems may be connected to one or may be included as one or more elements of system 400 (e.g., entertainment system, computing device, camera devices, remote cameras, wireless key fob, wall mounted user interface device, cell radio module, battery, alarm siren, door lock, lighting system, thermostat, home appliance monitor, utility equipment monitor, and so on). In some embodiments, all of the elements shown in FIG. 4 need not be present to practice the present systems and methods. The devices and subsystems can be interconnected in different ways from that shown in FIG. 4. In some embodiments, an aspect of some operation of a system, such as that shown in FIG. 4, may be readily known in the art and are not discussed in detail in this application. Code to implement the present disclosure can be stored in a non-transitory computer-readable medium such as one or more of memory 410 or other memory. The operating system provided on input/output controller module 420 may be iOS®, ANDROID®, MS-DOS®, MS-WINDOWS®, OS/2®, UNIX®, LINUX®, or another known operating system.

The transceiver module 430 may include a modem configured to modulate the packets and provide the modulated packets to the antennas 435 for transmission and/or to demodulate packets received from the antennas 435. While the device (e.g., 205-b) may include a single antenna 435, the device (e.g., 205-b) may have multiple antennas 435 capable of concurrently transmitting and/or receiving multiple wireless transmissions.

The device 205-b may include an album module 215-b, which may perform the functions described above for the album modules 215 of device 205 of FIGS. 2 and 3.

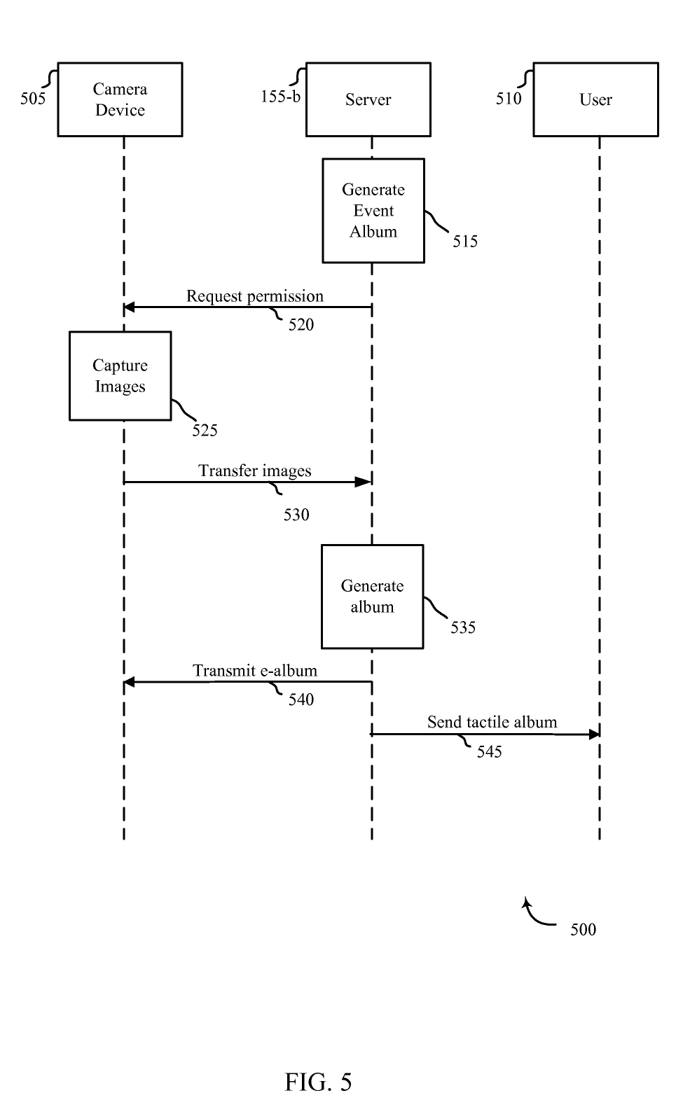

FIG. 5 is a swim diagram 500 illustrating communication relating to a camera device 505, a server 155-a, and a user 510 relating to an automation system. The camera device 505 may be one example of the local computing device 115, 120, and/or remote computing device 140 described with reference to FIG. 1, among others. The camera device 505 may be a single camera device or multiple camera devices. The server 155-b may be one example of server 155 and/or control panel 135 described with reference to FIG. 1 and may also be an example of the device 205 described with reference to FIGS. 2-4, among others. The user 510 may be a user of the camera device 505 or may be a user of the automation system or a user of the image album.

At block 515, the server 155-b may generate an event image album. The event image album may be an image album associated with a user of an automation system and may be a private event. Alternatively, the image album may be a public album and be associated with a public event. The server 155-b may request permission 520 to access images on a camera device 505. The images may be uploaded from the camera device 505 to the server 155-b or the server 155-b may pull the images from the camera device 505. The camera device 505 may capture images 525. The images may be within connection parameters established by the server 155-b. For example, the images may be taken within a predetermined start time and end time. The images may be taken within a specific geo-fence associated with the event album.

The images may be transferred 530 to the server 155-b. The server 155-b may receive the images. The camera device 505 may push the images to the server 155-b. Alternatively, the server 155-b may retrieve the images from the camera device 505. The server 155-b may use the images to generate an album 535. The image album may be an album generated for all users or may be personalized for each user. The server 155-b may transmit an e-album to the camera device 505. Alternatively and/or additionally, the server 155-b may send a tactile, physical album 545 to the user 510.

In some embodiments, the camera device 505 may transfer the images to a local computing device such as a desktop or laptop computer which may then transfer the images to the server 155-b to be incorporated into the album. In another embodiment, the user 510 may not be a user associated with the camera device 505 but may be an attendee of the event and may wish to receive an album. The album may comprise a tactile album as shown in the diagram or may comprise an e-album. In another embodiment, the e-album may not be sent to the camera device 505 but may rather may be transmitted to an image contributor or attendee in an SMS, email, social media message, or the like. The e-album may additionally be generated in a shared album online which the recipient may be invited to view.

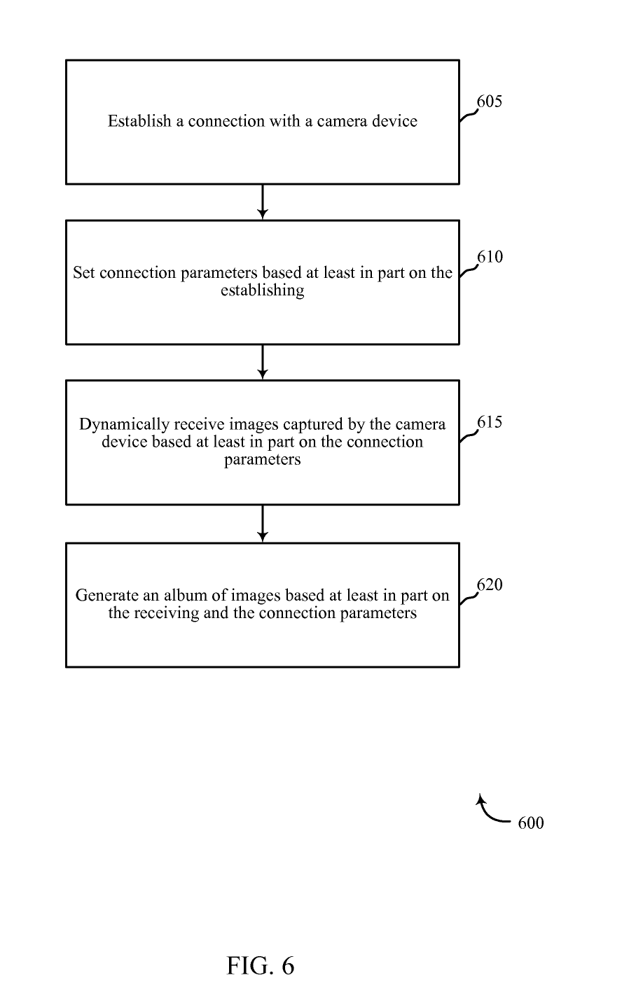

FIG. 6 is a flow chart illustrating an example of a method 600 for generating image albums in accordance with various aspects of the present disclosure. For clarity, the method 600 is described below with reference to aspects of one or more of the device 205 described with reference to FIGS. 2-4, and/or aspects of one or more of the remote server 155 and/or control panel 135 described with reference to FIG. 1. In some examples, a server 155 may execute one or more sets of codes to control the functional elements of the control panel to perform the functions described below. Additionally or alternatively, the control panel 135 and/or the remote server may perform one or more of the functions described below using special-purpose hardware.

At block 605, the method 600 may include establishing a connection with a camera device. The connection may include reaching out to all camera devices associated with an automation system within a predetermined geographical region. The geographical region may be defined by a geo-fence. The geographical region may surround a public event location or a private location. For example, the geographical region may surround a stadium, park, school, and the like. Alternatively, the geographical region may surround a private residence associated with the automation system. In some embodiments, the camera device may be established by a user who may have requested an image album be generated in association with an event. The user may request an image album and may provide various image contributors.

At block 610, the method 600 may include setting connection parameters based at least in part on the establishing. The connection parameters may include a user of the camera device agreeing to contribute their images to an image album associated with a specific event. The event may be a private event at a residence such as a family gathering, a holiday, a birthday party, a picnic, a barbeque, and the like. A user of the automation system may request generation of the event album. Alternatively, the event may be a public event. The connection parameters may additionally include a start time and an end time. Images taken between the start and end times may be acceptable to contribute to an event album.

The operations at blocks 605, 610 may be performed using the event module 305 and/or collection module 310 described with reference to FIG. 3, among others.

At block 615, the method 600 may include dynamically receiving images captured by the camera device based at least in part on the connection parameters. The camera device may automatically send the images to a server or other device associated with the method 600. Alternatively, the server or other device may pull the images from the camera device at a certain time and/or based on one or more parameters. The images may be images allowed to be shared based on the connection parameters. In some embodiments, the images may be received after collection parameters have expired. For example, images may be received after the event has ended to ensure all images associated with the event are received.

The operations at block 615 may be performed using the collection module 310 described with reference to FIG. 3, among others.

At block 620, the method 600 may include generating an album of images based at least in part on receiving images and the connection parameters. The album of images may be a generic album generated with all of the images received or may be specific to a user or other recipient of the album. The album may be an electronic album and/or may be a physical album. The connection parameters may establish album preferences such as length of album, number of images, distribution of images such as distribution of image subjects and distribution of images throughout the album, some combination, and/or the like. In some embodiments, the images may include video images and/or audio data which may be incorporated into an electronic album and/or a tactile album.

Thus, the method 600 may provide for image album generation relating to automation/security systems. It should be noted that the method 600 is just one implementation and that the operations of the method 600 may be rearranged or otherwise modified such that other implementations are possible.

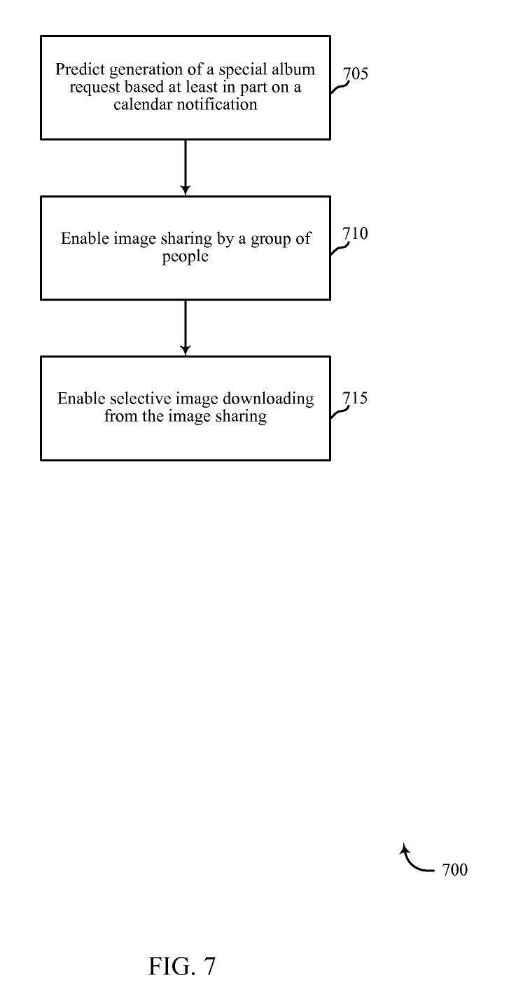

FIG. 7 is a flow chart illustrating an example of a method 700 for generating image albums in accordance with various aspects of the present disclosure. For clarity, the method 700 is described below with reference to aspects of one or more of the device 205 described with reference to FIGS. 2-4, and/or aspects of one or more of the remote server 155 and/or control panel 135 described with reference to FIG. 1. In some examples, a server 155 may execute one or more sets of codes to control the functional elements of the control panel to perform the functions described below. Additionally or alternatively, the control panel 135 and/or the remote server may perform one or more of the functions described below using special-purpose hardware.

At block 705, the method 700 may include predicting generation of a special album request based at least in part on a calendar notification. The prediction may include predicting image contributors, start time, end time, album distribution, image collection, some combination, and/or the like. The method 700 may include pinging an owner of the calendar notification to confirm the connection parameters and event details. The owner of the calendar notification may have the option of altering, editing, deleting, and/or otherwise changing the event details and connection parameters.

The operations at block 705 may be performed using the event module 305 described with reference to FIG. 3, among others.

At block 710, the method 700 may include enabling image sharing by a group of people. For example, after the event parameters are generated and images are collected, recipients of the album may have the option to share the collected images. In some embodiments, the images may be shared among attendees of a private event. In other embodiments, the method 700 may enable a recipient of the album to distribute the album electronically either via hyperlinks in an email, a SMS message, or via various social media sites. In some embodiments, image contributors may have limited the sharing ability of their images. For example, image contributors may have the option to limit the potential distribution of their images if they do not wish their images to be distributed via social media or the like, which enables an increased level of security and privacy. In these embodiments, if another recipient attempts to share images, selective images may be prohibited form distribution.

At block 715, the method 700 may include enabling selective image downloading from the image sharing. The image downloading may enable a recipient of an album to locally save a copy of an image from the event and/or album to for personal use. The selective image downloading may be limited by image contributor preferences. For example, a recipient of the album may not have permission to download one or more images due to image contributor confinements on the images (e.g., not allowing those containing the contributor themselves but allowing those containing scenery and/or the venue). The image contributor may have limited access to the images contributed from his/her camera device. In some embodiments, if a recipient wishes to download an image, permission may be required from the image contributor and/or an album administrator.

The operations at blocks 710, 715, may be performed using the distribution module 320 described with reference to FIG. 3, among others. Each of the operations may be added to, combined with, and/or otherwise modified based on those referenced for method 600 and/or those discussed elsewhere in this disclosure.

Thus, the method 700 may provide for image album generation relating to automation/security systems. It should be noted that the method 700 is just one implementation and that the operations of the method 700 may be rearranged or otherwise modified such that other implementations are possible.

In some examples, aspects from two or more of the methods 600 and 700 may be combined and/or separated. It should be noted that the methods 600 and 700 are just example implementations, and that the operations of the methods 600 and 700 may be rearranged or otherwise modified such that other implementations are possible.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, e.g., a combination of a DSP and a microprocessor, multiple microprocessors, one or more microprocessors in conjunction with a DSP core, and/or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

This disclosure may specifically apply to security system applications. This disclosure may specifically apply to automation system applications. In some embodiments, the concepts, the technical descriptions, the features, the methods, the ideas, and/or the descriptions may specifically apply to security and/or automation system applications. Distinct advantages of such systems for these specific applications are apparent from this disclosure.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A method for security and/or automation systems, comprising:
establishing a connection with a camera device;
setting connection parameters based at least in part on the establishing;
dynamically receiving images captured by the camera device based at least in part on the connection parameters; and
generating an album of images based at least in part on the receiving and the connection parameters.

2. The method of claim 1, further comprising:
predicting generation of a special album request based at least in part on a calendar notification.

3. The method of claim 1, further comprising:
enabling image sharing by a group of people; and
enabling selective image downloading from the image sharing.

4. The method of claim 3, wherein the group of people is established at least in part by generating a geographical boundary around a location associated with a public event.

5. The method of claim 4, further comprising:
requesting permission to access or receive images relating to the public event.

6. The method of claim 1, wherein the connection parameters further comprise:
setting a start time for dynamically receiving images; and
setting an end time for dynamically receiving images.

7. The method of claim 6, wherein the start time and the end time coordinate with a calendar event on a user's calendar.

8. The method of claim 6, wherein the start time and the end time coordinate with a holiday.

9. The method of claim 1, wherein establishing the connection with the camera device comprises:
establishing a connection with multiple camera devices.

10. The method of claim 9, wherein a user of an automation system determines the multiple camera devices selected for establishing the connection.

11. The method of claim 1, further comprising:
automatically requesting a physical album to be generated.

12. The method of claim 1, wherein generating the album of images is based at least in part a previously generated album.

13. The method of claim 1, wherein generating the album of images is based at least in part a previous public event.

14. The method of claim 1, wherein the connection parameters define the album of images.

15. An apparatus for security and/or automation systems, comprising:
a processor;
memory in electronic communication with the processor; and
instructions stored in the memory, the instructions being executable by the processor to:
establish a connection with a camera device;
set connection parameters based at least in part on the establishing;
dynamically receive images captured by the camera device based at least in part on the connection parameters; and
generate an album of images based at least in part on the receiving and the connection parameters.

16. The apparatus of claim 15, wherein the instructions are further executable to:
predict generation of a special album request based at least in part on a calendar notification.

17. The apparatus of claim 15, wherein the instructions are further executable to:
enable image sharing by a group of people; and
enable selective image downloading from the image sharing.

18. A non-transitory computer-readable medium storing computer-executable code, the code executable by a processor to:
establish a connection with a camera device;
set connection parameters based at least in part on the establishing;
dynamically receive images captured by the camera device based at least in part on the connection parameters; and
generate an album of images based at least in part on the receiving and the connection parameters.

19. The computer-readable medium of claim 18, wherein the code is further executable to:
enable image sharing by a group of people; and
enable selective image downloading from the image sharing.

20. The computer-readable medium of claim 19, wherein the group of people are established by generating a geographical boundary around a location associated with a public event.
